(19) United States
(12) Patent Application Publication
(10) Pub. No.: US 2008/0142549 A1
(43) Pub. Date: Jun. 19, 2008

(54) Apparatus for the discharge of product from a bulk bag

(76) Inventor: Mark Michael Kosich, Bailey, NC (US)

Correspondence Address: Mark M. Kosich, 7739 OLD RALEIGH RD, BAILEY, NC, 27807, US

(21) Appl. No.: 12/009,416

(22) Filed: Jan. 18, 2008

Related U.S. Application Data
(63) Continuation-in-part of application No. 10/937,865, filed on Sep. 9, 2004.
Application No. 10/937,865 is a continuation-in-part of application No. 10/791,520, filed on Mar. 2, 2004, now abandoned.

(51) Int. Cl. B67D 5/64; B65D 35/56; B65D 88/26

(52) U.S. Cl. 222/160; 222/181.1; 222/105; 222/462

(57) ABSTRACT

An apparatus for the discharge of product from a bulk bag utilizing a container inverter has an enclosure with a floor, plurality of side walls, horizontal arm and outlet spout adapter. Vertical lifting and lowering to control the floor or horizontal control arm participate in securing the bulk bag. An outlet spout adapter attaching to the horizontal arm has components to secure an outlet spout in place and also a valve or flow control device. By inverting the container inverter up to one-hundred and eighty degrees, product stored within the bulk bag can be discharged. Prior to inverting, the bulk bag can be secured in place by loop or sleeve holders and the bag sides can be held in place by vacuum to interior surfaces of the enclosure. The apparatus can be mounted on a lifting and pivoting mechanism to position the enclosure over a desired discharge point.

### CROSS REFERENCE TO RELATED APPLICATION

This is a continuation in part of Ser. No. 10/791,520, filed on Mar. 2, 2004.

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of bulk bag discharge equipment and more specifically to an apparatus for the discharge of product from a bulk bag. Bulk bags are inexpensive intermediate containers usually constructed of woven polypropylene or polyester fabric. This discussion relates primarily to bulk bags containing products classified as bulk solids. Bulk bags are used in many industries to transport and store chemicals, plastic resins, powder food ingredients, pharmaceutical intermediates and various powder and granular products along with many other variations of products with a wide range of particle size and shape. They have become a preferred shipping container over boxes, drums and other rigid containers because they are less expensive and because they can be easily folded and returned for reuse or more easily and cheaply disposed of.

Bulk bags are typically constructed in a cube shape for efficient shipping and ease of handling. Often sized to hold thirty to forty cubic feet of material, one ton is very common weight of product packaged in a bulk bag. A bag is most often constructed as a cube with a top and bottom panel. The top panel has an inlet opening and a spout for filling and an outlet opening with spout through the stored product is discharged.

To discharge product from a bulk bag, it is usually suspended by four loops located at the top corners of the container and placed onto a steel framework where an operator can reach under the bag to connect the outlet spout to a chute that may be part of a particular process inlet, metering device or conveying device. A valve can be mounted on the support frame through the outlet spout passes. The spout is untied and the valve is opened to release the contents.

Numerous optional items have evolved for dealing with spout closure for re-tying the outlet spout when only a portion of the bag contents is discharged, compensating for bag drooping as product empties, dust control and coaxing non-free-flowing products through the outlet opening. These optional items are mounted on the bulk bag discharger framework. The discharger itself is usually mounted directly over a process inlet or it is placed away from the process while a conveyor is used to deliver the product to the process inlet.

Present method dischargers can stand twelve to eighteen feet tall, occupy a large volume of space and at best deliver the product to floor level. To the product up to a height where it can be delivered to a process inlet requires either a very high ceiling or the use of a conveyor. Hanging a bulk bag by loops located at the top corners takes up about ten inches vertical height. As product discharges from the bag, the entire container will elongate, hence the bag must be drawn upward to alleviate folds in the fabric and to prevent product from lodging in the folds.

Furthermore, conventional bulk bag discharge equipment does not allow for the speedy changeover and ease of accurate metering as other types of containers. Since an operator must work underneath of the bulk bag to connect and disconnect an outlet spout and initiate product flow, preparing a bulk bag for discharge is an uncomfortable, time consuming task. Disconnecting the outlet spout requires the operator to return underneath the bulk bag to close the valve, disconnect and retie the outlet spout. Because the product contained in the bulk bag rests just above the tie string, special enclosures and clamping devices are required to attach the outlet spout. Often, vacuum systems are employed to help minimize dust emission. Process hygiene is a persistent problem with present method bulk bag discharging.

Bulk bags are most often constructed with a flat panel on the bag bottom with an outlet opening and spout. This shape contributes to poor product flow from the container and is a factor in the need to hoist the bag to compensate for elongation as the bag empties. In some cases, cone shape bottom bags are used. A cone shape bottom can improve the ability of product to exit from the container and reduce the need to hoist upward. However, because this bulk bag design is shipped and stored with the cone on the bottom, handling is difficult. The cone needs to be pulled up the side of the bag and taped to the bag side during filling, shipping and storing. When the bag is hoisted for discharge, the cone must be released which causes product to rush from the square body of the bag and into the cone section.

Therefore, while bulk bags provide some efficiencies in the transport and storage of bulk solids, the present method hoisting of bulk bags for discharge is a somewhat inefficient and uncomfortable means for unloading product from the flexible container.

Boxes, Gaylord and other rigid containers are also used to transport and store bulk solids. These containers invariably are made with side wall enclosure and a floor while a lid covers the top opening. Present rigid container inverting equipment used to empty the contents of a rigid container usually comprises at least a floor and a cone shape funnel to cover the top opening. The funnel is often fixed to a horizontal control arm that can move up and down by a hydraulic cylinder. To secure the rigid container in place within the inverter, the funnel moves down onto the rim of the container and the rigid container provides resistance between the funnel and the floor. Sometimes, the floor instead is provided with the hydraulic lifting and lowering components. The floor lifts the container up until it contacts the fixed funnel. Once the container is in contact with the floor and the funnel, it is ready to be inverted. A valve or flow control device can be mounted onto the funnel outlet opening to stop or control the flow of product from the container. The interior surface of the funnel is exposed to product as the product leaves the container to exit the outlet opening. Therefore, there is cross-contamination of product from one container to the next. It is common to provide a liner to cover the interior surfaces of the rigid container. The liner protects the product from contact with the container surfaces and can act as a moisture barrier. When a rigid container is discharged by inverting, the liner tends to drop before the product empties. This fouls the funnel and funnel outlet preventing product from flowing from the container. A better method is needed to provide a container liner and yet also be able to line the funnel to eliminate product contact of the interior surface of the funnel. A better method is also needed to keep the flexible packaging material in place so as not to foul the funnel and funnel outlet.

There are potential advantages to using an inverter method for discharging the product stored within a bulk bag. Yet present method inverters do not provide the necessary components and adaptations to secure a flexible container for inverting and discharge. Also no provision is made to utilize the features that are presently incorporated in bulk bag design to line the funnel and eliminate product contact of the funnel and the potential for cross-contamination. Potential exists to use present method container clamping equipment to grasp a flexible container in order to secure it properly for inverting and also to further utilize the grasping action of such equipment to squeeze and therefore condition settled product for easier discharge from the container. There is also an advantage in using a flexible container instead of a lined rigid container by using vacuum to draw the flexible material to the interior surface of the inverter and thereby discharge the contents while holding the flexible container in place. This will avoid having the flexible container fall downward to foul the funnel and funnel outlet.

### BRIEF SUMMARY OF THE INVENTION

The primary advantage of the invention is to prepare a bulk bag for discharge in an upright position and then invert the flexible container in a manner that is similar to present method drum or box handling.

Another advantage of the invention is to mount a valve or flow control device on the top side of a bulk bag so that an operator will not have to work underneath of the bulk bag.

A further advantage of the invention is to improve the efficiency of handling a bulk bag by providing better ergonomics for an operator of bulk bag discharging equipment.

Yet another advantage of the invention is to increase productivity by providing more rapid changeover of bulk bags.

And yet another advantage of the invention is to improve hygiene in a bulk powder handling area and to minimize cross-contamination of various products when utilizing the same equipment.

A further advantage of the invention is to make use of the flexible characteristics of a bulk bag by utilizing moveable components to secure the flexible container and to manipulate the product stored within for enhanced product flow from the container.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed an apparatus for the discharge of product from a bulk bag comprising: a container inverter comprised of an enclosure with a floor, a plurality of side walls, and means to invert said enclosure up to one-hundred and eighty degrees, a bulk bag outlet spout adapter comprising an opening through which a bulk bag spout can be pulled through and means to secure said outlet spout in place, at least one horizontal arm connecting to said container inverter enclosure and supporting said outlet spout adapter, and means to secure and retain a bulk bag when the bulk bag is inverted.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a perspective view of an exemplary bulk bag.

FIG. 2′ is a perspective view of a component of the invention.

FIG. 2A is a perspective view of the invention.

FIG. 2A′ is a perspective view of a component of the invention.

FIG. 2B is a perspective view of the invention.

FIG. 2C is a perspective view of the invention.

FIG. 2D is a perspective view of the invention.

FIGS. 3 through 3C provide a perspective view of a sequence of operation of the invention.

FIG. 4 is a perspective view of the invention.

FIG. 4A is a perspective view of the invention.

FIG. 4B is a perspective view of the invention.

FIG. 4C is a perspective view of the invention.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

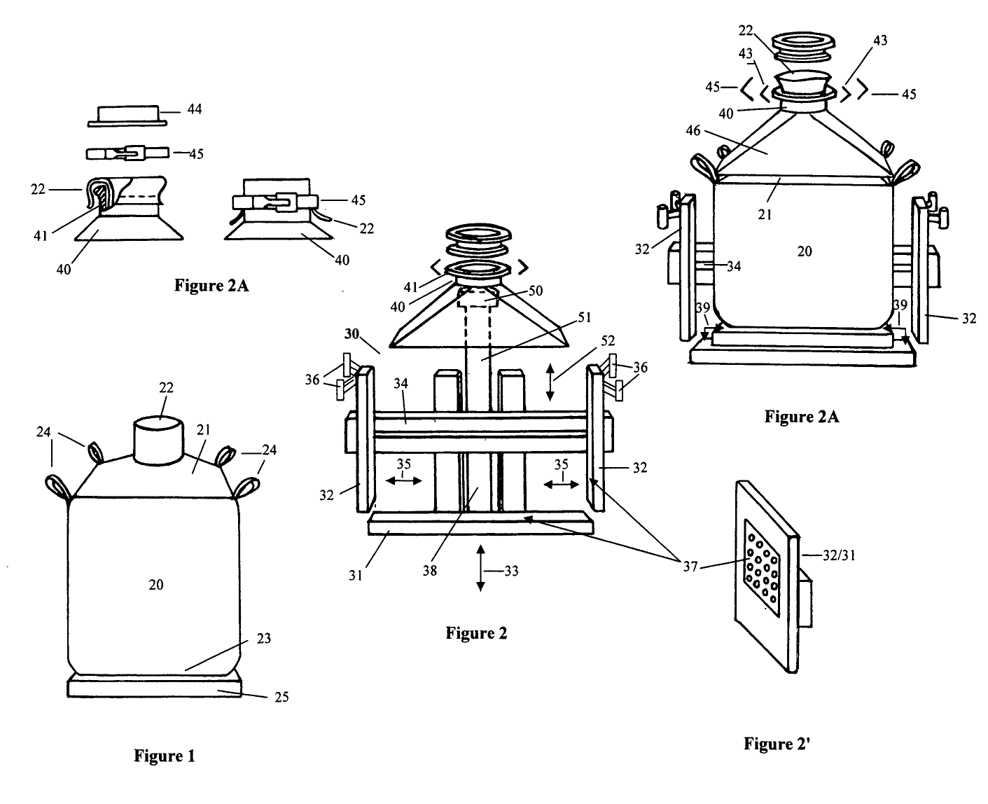

Turning first to FIG. 1, there is shown an exemplary bulk bag 20 comprising features similar to those most commonly found in the field of bulk bag handling with the main difference being that the bag featured in FIG. 1 has an outlet opening and spout 22 on the top panel 21 but no opening and spout on the bottom panel 23. As is typical with most bulk bags, lifting means are provided and are shown as loops 24. In some cases sleeves (not shown) are substituted for loops 24. It is common to move a bulk bag that is filled with product by placing the bag on a pallet 25 and using a forklift or pallet jack to transport the container.

In the case of the present invention, a bulk bag needs to have only a single outlet spout 22 and it should be positioned at first on the top panel 21 of bulk bag 20. With this configuration, bulk bag 20 can be filled with product and shipped in the tradition manner, as those skilled in the art will recognize.

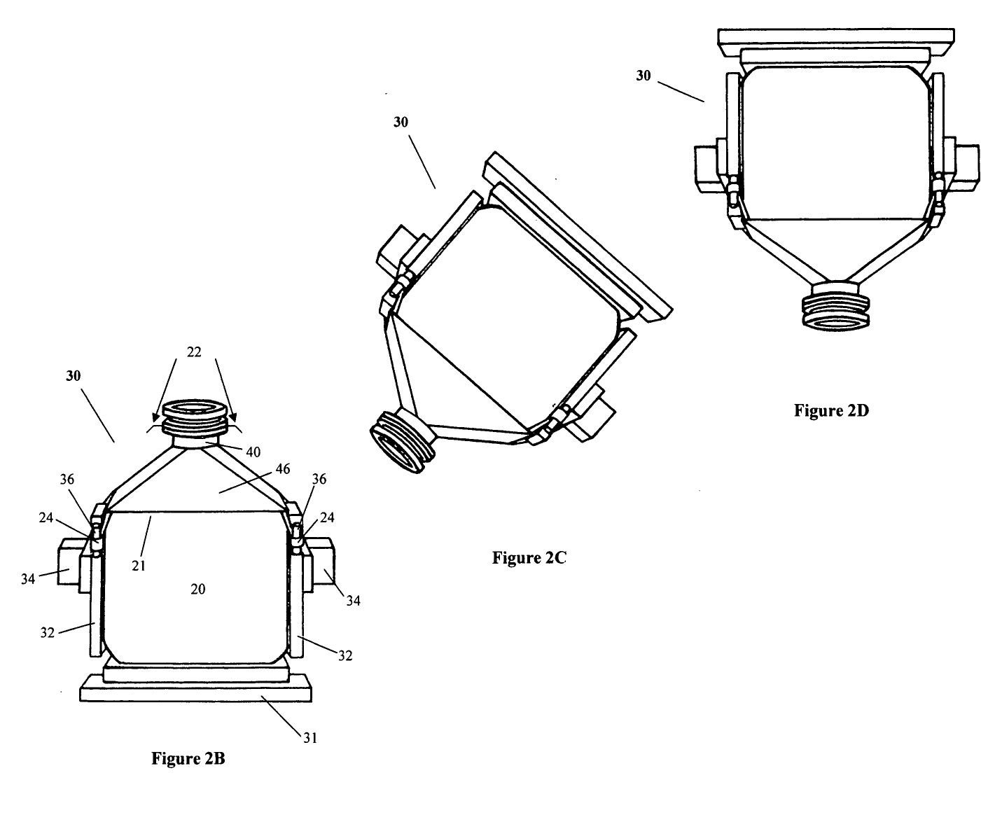

In accordance with the preferred embodiment, FIG. 2 shows a container inverter 30 comprised of an enclosure with a floor 31 and a plurality of side walls 32. A bulk bag outlet spout adapter 40 comprises an opening 41 through which a bulk bag spout can be pulled through and secured in place (shown later). At least one horizontal arm 50 connects to the container inverter 30 enclosure and supports outlet adapter 40. Horizontal arm 50 may also comprise vertically lifting and lowering means 52 as an integral part of its support structure 51. Lifting and lowering action is symbolized by dual arrow 52.

Floor 31 may also comprise vertically lifting and lowering means 38 as an integral part of its support structure 51. Lifting and lowering action is symbolized by dual arrow 33. Floor lifting 38 and lowering means may be provided in addition to horizontal arm lifting and lowering means 52 or independently.

Further, means to secure and retain a bulk bag when the bulk bag is inverted are also provided. FIG. 2 illustrates a plurality of bulk bag loop or sleeve retainer components 36.

Additional means to secure and retain a bulk bag may be accomplished with means to hold at least one bulk bag surface plane in place during product discharge. As Shown in FIG. 2′, at least one vacuum means 37 located on at least one container inverter interior surface and designed to draw and hold at least one plane of the bulk bag 20 to the interior surface keeps the bulk bag material from slipping out of position. Vacuum means can be integrated into a side wall or the floor of the container inverter enclosure 30. A vacuum means integrated into floor 31 would be effective if bulk bag 20 were loaded into container inverter 30 without using a pallet 25. The bulk bag 20 can be lifted and moved using loops 24.

Further in accordance with the invention, means is provided for adjusting at least two opposing side walls of the container inverter 30. Operatively connecting at least two opposing side walls 32, means to increase or decrease the distance between the opposing walls 34, can be used to create free space horizontally to place a bulk bag 20 within container inverter enclosure 30. When the bulk bag 20 is placed within the container inverter enclosure 30, the distance between the opposing walls 32 may be decreased. Operative connection is symbolized by dual arrow 35. Such means are presently readily available.

The relationship of bulk bag 20 to the invention will be better understood following a functional description as shown in the illustrated embodiment of FIGS. 2A through 2D.

Following the preferred procedure, FIG. 2A shows bulk bag 20 positioned within the enclosure of container inverter 30 with outlet adapter 40 in a raised position or as would be the case in an alternative embodiment, floor 31 would be in a lowered position. Means to increase or decrease the distance between the opposing walls 34 operatively connect at least two opposing side walls 32 and are adjusted for increased space between two opposing side walls 32.

If bulk bag 20 is handled on a pallet 25, pallet 25 may be held in place by means to secure a pallet to the floor of a container inverter 39; such means are presently readily available.

Floor 31 may be raised until bulk bag top panel 21 contacts outlet adapter 40 or outlet adapter 40 may be lowered until it contacts bulk bag top panel 21. Outlet spout 22 is pulled up through outlet adapter 40.

While outlet adapter 40 can be shaped in a number of different forms, a preferred embodiment has outlet adapter 40 in the form of a cone 46 shape with a larger circumference opening on a first end, and a smaller diameter opening on an opposing end, where outlet adapter 40 is located. This configuration is preferred when bulk bag top panel 21 shares a similar cone shape. A cone shaped outlet adapter 46, as those skilled in the art will recognize, facilitates more reliable product flow from a container.

Several options are available to secure outlet spout 22 to outlet adapter 40.

a) Outlet spout 22 may be connected to outlet adapter 40. A connecting means may include a “V” type clamp as illustrated by clamp 43. In this case, no chute or valve is used and product will begin flow as the container inverter rotates. FIG. 2A′ shows in cut away detail outlet spout 22 folded over flange 41 of outlet adapter 40.

b) As shown in FIG. 2A′, a chute 44 with matching means for connecting to outlet adapter 40 may be utilized. A connecting means may include a “V” type clamp as illustrated by clamp 45. It is recommended however, to attach outlet spout 22 together with these components. Alternatively, a valve or flow control device may be substituted for chute 44 and may be fixed or removably mounted to outlet adapter 40.

c) Another alternative to chute 44, an iris valve may be fixed or removably mounted to outlet adapter 40. Those who are skilled in the art will recognize that an iris valve permits outlet spout 22 to be pulled up through it so that the iris portion of the valve can be closed around outlet spout 22. Once the container inverter 30 is positioned for product discharge, the iris valve can be opened. Upon completion of product discharge, the valve may be closed again against outlet spout 22.

Continuing the preferred procedure, FIG. 2B shows the invention with means for adjusting at least two opposing side walls 34 in a closed position with opposing sides 32 against bulk bag 20. Outlet adapter 40 in the form of a cone 46 is in a lowered position against top panel 21; or floor 31 in a raised position.

Lifting means shown as loops 24 are secured to bulk bag loop or sleeve retainer components 36. Outlet spout 22 is secured to outlet adapter 40.

FIG. 2C shows the invention in a partially inverted position.

FIG. 2D shows the invention inverted one-hundred and eighty degrees and ready for product discharge. If a valve or flow control device is used, it can be actuated to allow product flow. Means to increase or decrease the distance between the opposing walls 34 may be utilized to pulse opposing side walls 32 to further facilitate product flow.

Upon completion of discharge, the procedure can be reversed and the container returned to its original upright position so that it may be removed from the apparatus.

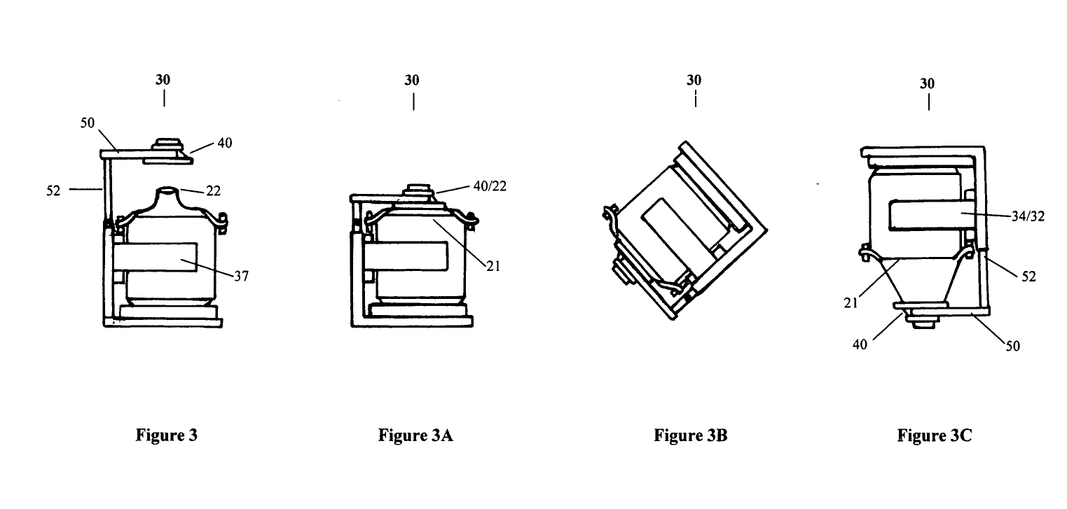

As illustrated in FIGS. 3 though 3C, outlet adapter 40 may be configured in a number of different ways and the preferred procedure may be altered without departing from my invention. Previously shown as a full hopper 46, outlet adapter 40 and horizontal arm 50 can be utilized in different ways to provide various handling advantages.

In FIG. 3, horizontal arm 50 with vertically lifting and lowering means 52 has outlet adapter 40 raised allowing bulk bag 20 to be placed within container inverter 30. At least one vacuum means 37 located on at least one container inverter interior surface may be activated to draw and hold at least one plane of the bulk bag 20 to the interior surface to keep the bulk bag material from slipping out of position.

FIG. 3A shows outlet adapter 40 lowered to connect outlet spout 22 and to apply pressure to top panel 21.

Further, as in FIG. 3B, the invention is shown in a partially inverted position.

And finally in FIG. 3C, the invention is shown inverted one-hundred and eighty degrees and ready for product discharge. If a valve or flow control device is used, it can be activated to induce produce product flow. At this stage, outlet adapter 40 can be extended away from top panel 21 by extending horizontal arm 50 with vertically lifting and lowering means 52. This procedure extends top panel 21 into a cone shape to help facilitate product flow. Arm 50 can also be pulsed to help jog product from the cone area of top panel 21. In addition means to increase or decrease the distance between the opposing walls 34 may be utilized to pulse opposing side walls 32 to further facilitate product flow.

Upon completion of discharge, the procedure can be reversed and the container returned to its original upright position so that it may be removed from the apparatus.

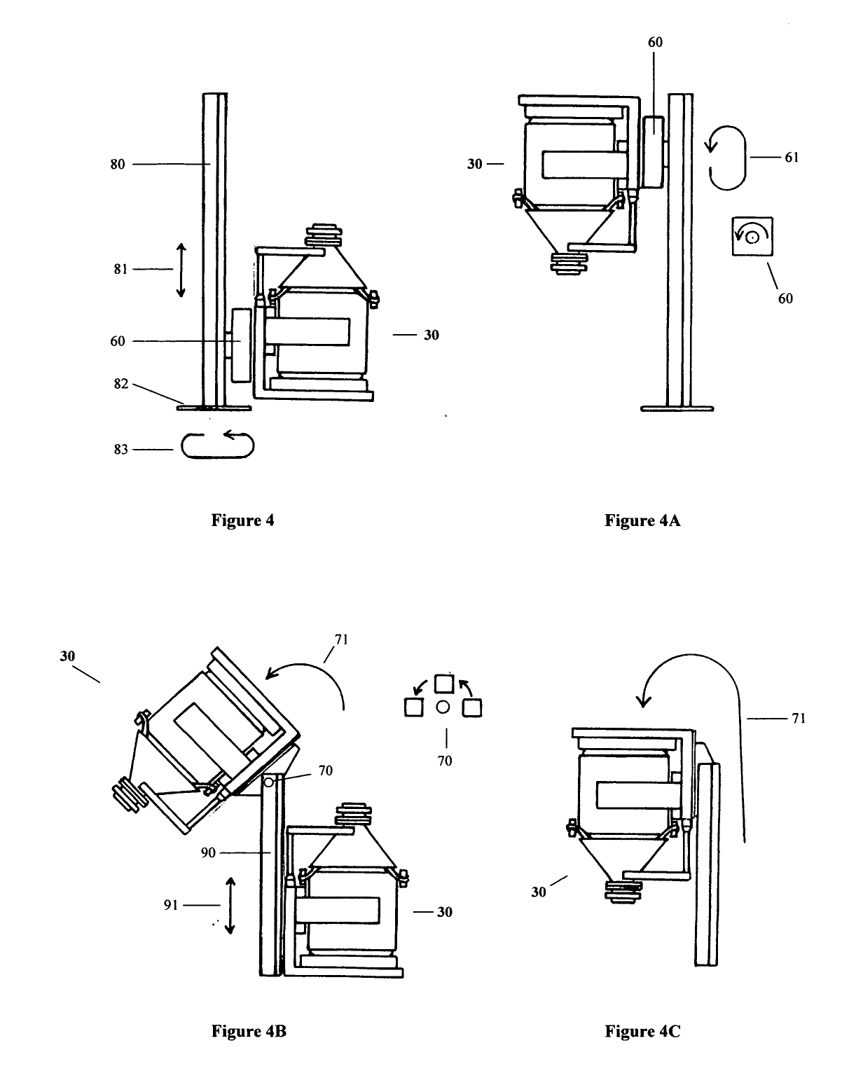

The relationship of the invention to a process for product transfer will be better understood following a description of FIGS. 4 through 4C.

As illustrated in FIG. 4, height adjustment means 80 is provided to raise and lower container inverter 30 to an appropriate discharge height. Several means for height adjustment are readily available. Some examples may include column lift and linear rail type lift.

A lift pivot means 82 provides for rotationally pivoting the height adjustment means structure about a vertical axis. Rotation action is indicated by circular arrow 83. This rotation action permits the positioning of container inverter 30 over a desired discharge point.

FIG. 4A shows container inverter 30 with a rotating device 60 that rotates on an axis that is perpendicular to the object being inverted. The rotational action is indicated by circular arrow 61. This provides a turntable type rotation.

FIG. 4B shows height adjustment means 90, which is a non-pivoting lift, to raise and lower container inverter 30 to an appropriate discharge height. Several means for height adjustment are readily available. Some examples may include column lift and linear rail type lift.

The invention 30 is shown with a rotating device 70 that rotates on an axis that is horizontal to the object being inverted so that the object being rotated moves over the horizontal axis in an arching manner. The arching rotational action is indicated by arching arrow 71.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. An apparatus for the discharge of product from a bulk bag comprising:
a container inverter comprised of an enclosure with a floor, a plurality of side walls, and means to invert said enclosure up to one-hundred and eighty degrees;
a bulk bag outlet spout adapter comprising an opening through which a bulk bag spout can be pulled through and means to secure said outlet spout in place;
at least one horizontal arm connecting to said container inverter enclosure and supporting said outlet spout adapter; and
means to secure and retain a bulk bag when the bulk bag is inverted

2. An apparatus for the discharge of product from a bulk bag as claimed in claim 1, said container inverter further comprising means to secure a pallet to the floor of said inverter

3. An apparatus for the discharge of product from a bulk bag as claimed in claim 1, said container inverter further comprising means for adjusting at least two opposing side walls of said inverter, thereby operatively connecting at least two opposing side walls and providing the means to increase or decrease the distance between said opposing walls, in order to create free horizontal space to place said bulk bag within said container inverter; and to apply pressure to at least two vertical sides of said bulk bag

4. An apparatus for the discharge of product from a bulk bag as claimed in claim 1, wherein said means to secure and retain a bulk bag while the bulk bag is inverted comprise a plurality of bulk bag loop or sleeve retainer components

5. An apparatus for the discharge of product from a bulk bag as claimed in claim 1, said floor further comprising vertically lifting and lowering means, to lift and lower said bulk bag in relation to said outlet spout adapter

6. An apparatus for the discharge of product from a bulk bag as claimed in claim 1, said horizontal arm further comprising vertically lifting and lowering means, to lower and lift said outlet spout adapter in relation to said bulk bag

7. An apparatus for the discharge of product from a bulk bag as claimed in claim 1, said container inverter further comprising means to hold at least one said bulk bag surface plane in place during product discharge,

8. An apparatus for the discharge of product from a bulk bag as claimed in claim 1, wherein said outlet spout adapter is in the form of a cone shape with a larger circumference opening on a first end and a smaller diameter opening on an opposing end

9. An apparatus for the discharge of product from a bulk bag as claimed in claim 1, said container inverter support structure further comprising height adjustment means, to lift said container inverter to an appropriate discharge height

10. An apparatus for the discharge of product from a bulk bag as claimed in claim 1, said container inverter support structure further comprising a pivot means to rotationally pivot said structure container inverter about a vertical axis, to position said container inverter over a desired discharge point

11. An apparatus for the discharge of product from a bulk bag as claimed in claim 1, further comprises a valve or flow control device fixed or removably mounting to said outlet spout adapter

12. An apparatus for the discharge of product from a bulk bag as claimed in claim 1, said means to secure said outlet spout in place further comprises means to secure both outlet spout and valve or flow control device

13. An apparatus for the discharge of product from a bulk bag as claimed in claim 1, said means to rotate said enclosure up to one-hundred and eighty degrees provides rotation on a perpendicular horizontal axis, so that said enclosure pivots on said axis and thereby rotates on said perpendicular horizontal axis in a turntable manner

14. An apparatus for the discharge of product from a bulk bag as claimed in claim 1, said means to rotate said enclosure up to one-hundred and eighty degrees provides rotation on a parallel horizontal axis, providing arching rotational action over said horizontal axis

15. An apparatus for the discharge of product from a bulk bag as claimed in claim 7, wherein said means to hold at least one said bulk bag surface plane in place during product discharge comprises at least one vacuum means located on at least one container inverter interior surface and designed to draw and hold at least one plane of said bulk bag to said interior surface to keep said bulk from slipping out of position

16. An apparatus for the discharge of product from a bulk bag as claimed in claim 11, wherein said valve is comprised of the iris type through which said bulk bag outlet spout can be pulled through and held in position by closing said iris valve tightly around said spout
